(19) United States
(12) Patent Application Publication
(10) Pub. No.: US 2024/0181476 A1
(43) Pub. Date: Jun. 6, 2024

(54) CONE APPLICATOR WITH SAFETY SKIRT

(71) Applicant: Roger Pierce, Phoenix, AZ (US)

(72) Inventor: Roger Pierce, Phoenix, AZ (US)

(21) Appl. No.: 18/518,842

(22) Filed: Nov. 24, 2023

Related U.S. Application Data
(60) Provisional application No. 63/429,421, filed on Dec. 1, 2022.

(51) Int. Cl. B05B 1/28; A01M 7/00

(52) U.S. Cl. CPC B05B 1/28; A01M 7/0064

(57) ABSTRACT

In one example, a safety applicator can include a body defining an upper chamber, a nozzle coupled to the body and defining a lower chamber, and a skirt coupled to the body. The lower chamber of the nozzle can be connected to the upper chamber of the body to define a passage through the device. The skirt can be configured to inhibit a liquid escaping from the nozzle in response to the liquid being injected through the nozzle. In various embodiments, the skirt defines an opening to relieve pressure in response to the liquid being injected through the nozzle. The body, the nozzle, and the skirt can be formed integrally. The body, the nozzle, and the skirt can comprise a molded liquid. The skirt may comprise a bell-shaped geometry. Other example devices and related methods are also disclosed herein.

### CROSS-REFERENCE TO RELATED APPLICATIONS

This application claims priority to U.S. Provisional Patent Application No. 63/429,421 entitled “CONE APPLICATOR WITH SAFETY SKIRT” and filed on Dec. 1, 2022, which is incorporated herein by reference.

### TECHNICAL FIELD

The following description generally relates to chemical delivery tools, and more particularly, to an applicator with a safety feature for delivering pesticides.

### BACKGROUND

Pest control techniques rely on chemicals to suppress insects. Chemicals are dangerous to human beings, and the chemicals used in pest control are no different. Over time, exposure to chemicals accumulates and can cause deleterious effects on pest control professionals. Current techniques and tools can cause control chemicals to contact the person applying them.

Chemical delivery techniques vary depending on the targeted species of insect and location. Termites, for example, are often targeted by drilling a hole into a slab and injecting a liquid chemical into the hole. The liquid pesticide sometimes squirts out of the hole. The airborne pesticide can make skin contact.

### SUMMARY

Systems, methods, and devices of the present disclosure relate to safe delivery of pesticides or other liquids into substrates. An example safety device can include a body defining an upper chamber, a nozzle coupled to the body and defining a lower chamber, and a skirt coupled to the body. The lower chamber of the nozzle can be connected to the upper chamber of the body to define a passage through the device. The skirt can be configured to inhibit a liquid escaping from the nozzle in response to the liquid being injected through the nozzle.

In various embodiments, the skirt defines an opening to relieve pressure in response to the liquid being injected through the nozzle. The body, the nozzle, and the skirt can be formed integrally. The body, the nozzle, and the skirt can comprise a molded liquid. The skirt may comprise a bell-shaped geometry. The body may comprise a cylindrical or annular geometry. The skirt can terminate at a rim, and a tip of the nozzle may protrude from the skirt past the rim.

Another example device can comprise a body, a nozzle coupled to the body, and a skirt coupled to the body. The skirt may extend at least partially around the nozzle. A passage can be defined through the body and the nozzle.

An example method of delivering liquid into a substrate can include the step of coupling an injector to an applicator, wherein the applicator comprises a body, a nozzle coupled to the body, and a skirt coupled to the body. The skirt may be disposed at least partially about the nozzle. The applicator may be pressed towards an aperture defined in the substrate. A liquid may be injected into the substrate through a passage defined by the body and the nozzle. A projection of the liquid can be calmed in the skirt in response to the liquid escaping from the substrate or the nozzle.

In various embodiments, the step of pressing the applicator towards the aperture formed in the substrate can further include sealing a tip of the nozzle against the substrate around aperture. Pressing the applicator towards the aperture formed in the substrate can also include pressing a rim of the skirt against the substrate. The skirt can define an opening to relieve pressure in response to injecting the liquid into the substrate. A pesticide delivery device can be pressed against an inner diameter of the body to form a seal. The body, the nozzle, and the skirt can comprise a molded material.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the illustrations.

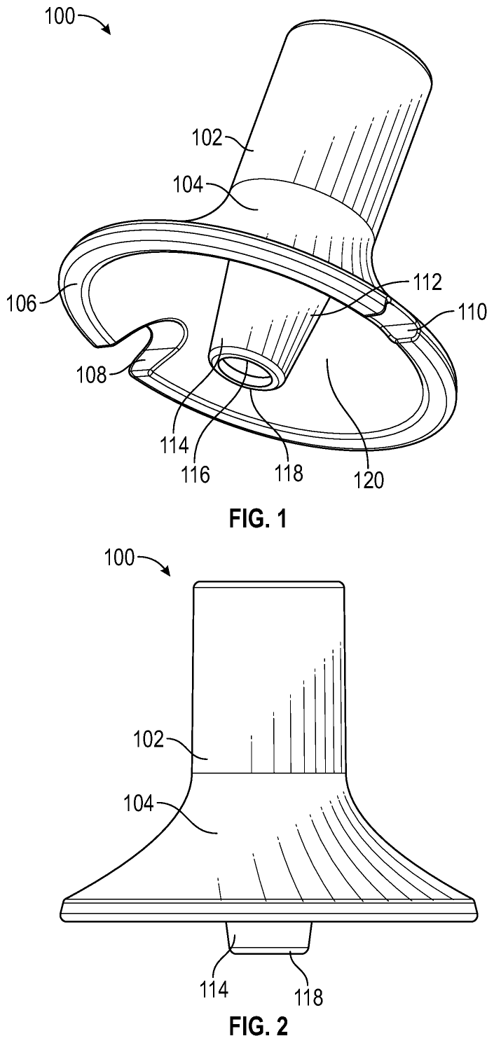

FIG. 1 illustrates a bottom-perspective view of a cone applicator with a safety feature, in accordance various embodiments;

FIG. 2 illustrates an elevation view of a cone applicator with a safety feature, in accordance various embodiments;

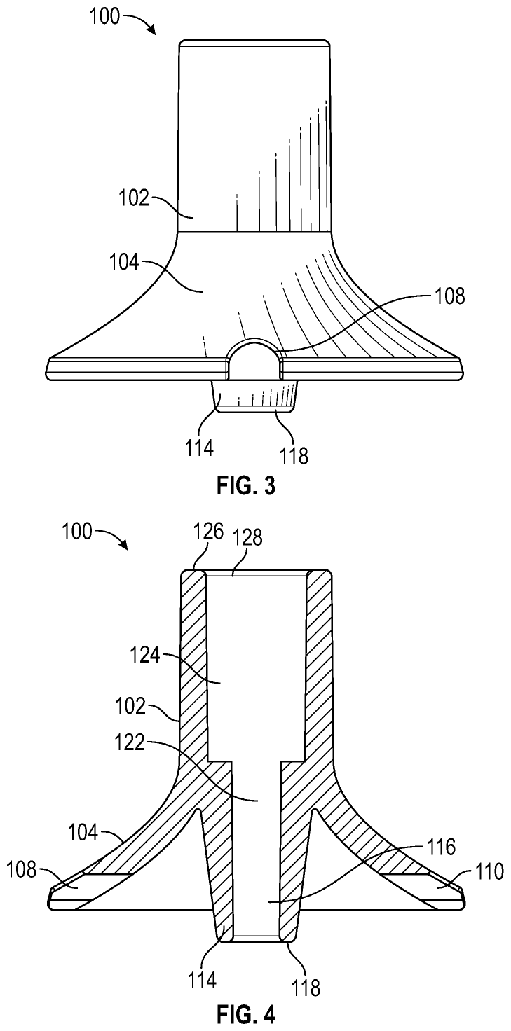

FIG. 3 illustrates an elevation view of a cone applicator with a safety feature and a release opening, in accordance various embodiments;

FIG. 4 illustrates a cross-sectional view of a cone applicator with a safety feature along line A-A from FIG. 3, in accordance various embodiments;

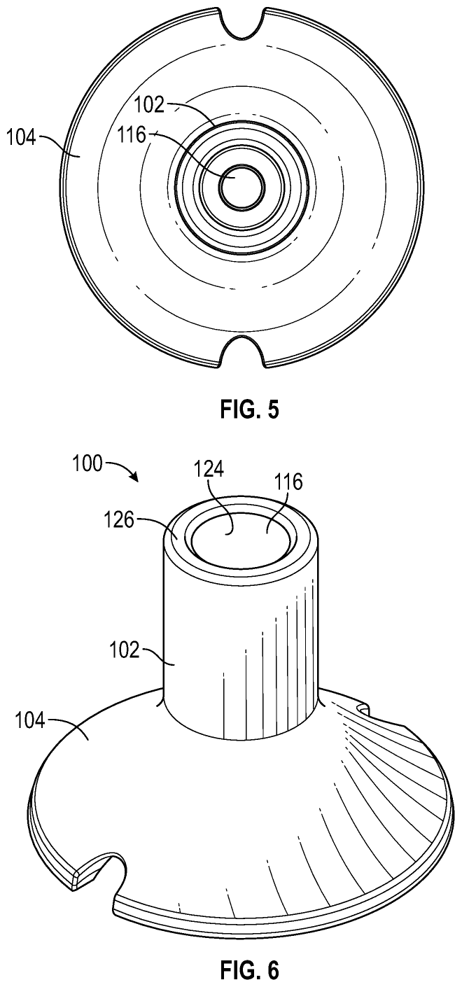

FIG. 5 illustrates a top view of a cone applicator with a safety feature, in accordance various embodiments; and

FIG. 6 illustrates a top-perspective view of a cone applicator with a safety feature, in accordance various embodiments.

### DETAILED DESCRIPTION

The following detailed description is intended to provide several examples that will illustrate the broader concepts set forth herein, but it is not intended to limit the invention or applications of the invention. Furthermore, there is no intention to be bound by any theory presented in the preceding background or the following detailed description.

Embodiments of the subject matter described herein generally relate to an applicator for a chemical pesticide. In typical operation, a conical tip of the applicator is oriented over a hole defined in a slab or other substrate, then pressed towards the slab or substrate. The conical tip forms a seal in many instances, though on occasion the tip does not seal with the slab. Pesticide ejected from the hold in the slab is captured by a safety skirt forming surrounding the conical tip. The safety skirt tends to prevent chemicals spraying from the conical tip or the hole in the slab onto walls, ceilings, or the person delivering the chemicals. In that regard, the cone applicator of the present disclosure tends to reduce pesticide spills and exposure.

Referring now to FIG. 1, applicator 100 is shown, in accordance with various embodiments. Applicator 100 comprises a cylindrical body 102 and a skirt 104. The depicted skirt 104 is a bell-shaped cover or bell cover with a round geometry, though polygonal, irregular, or other shapes could be used for skirt 104 in various embodiments. In that regard, skirt 104 may comprise a bell-shaped geometry. The outer surface of skirt 104 terminates at rim 106. Rim 106 may be rounded, flat, or otherwise shaped to engage with a slab during use. Rim 106 may make contact with a slab or draw close to a slab during use in response to a compressive force driving applicator 100 towards the slab.

Skirt 104 defines opening 108 and opening 110 to relieve pressure in response to application of pesticides. Excess pesticide and air may escape through opening 108 or opening 110. Although two pressure-relief openings are shown in the example embodiments of FIG. 1, other embodiments might have more, fewer, or zero pressure relief openings. Nozzle 112 extends into interior cavity 120 of skirt 104. Tip 114 of nozzle 112 extends through the opening defined by rim 106. In that regard, tip 114 protrudes from skirt 104 beyond rim 106 when viewed from the side.

In various embodiments, nozzle 112 and body 102 define a cavity extending completely through applicator 100. Passage 116 terminates at rim 118, which is disposed at the distal end of tip 114 and of lower chamber 122. Passage 116 operates as a conduit to deliver pesticide into a slab. Pesticides are injected into an opening defined rim 126 of by body 102, pass through passage 116, and exit through an opening defined by rim 118. Excess pesticide forcefully exiting tip 114 can be captured or calmed by the interior surface of skirt 104 defining cavity 120.

Referring now to FIG. 2, applicator 100 is shown in an elevation view, in accordance with various embodiments. Body 102 and skirt 104 may have a combined height of about 1.2 inches, 1.4 inches, 1.6 inches, 1.8 inches, or 2 inches in some embodiments, though applicator 100 can be made and used in any size. As used herein with reference to distance, the term ‘about’ may mean+/−5%, +/−10%, +/−15%, or +/−20%.

In various embodiments, tip 114 extends from the bottom of skirt 104 as viewed in the orientation the example embodiment in FIG. 2. The total height of applicator 100 including tip 114 of nozzle 112 may be about 1.35, 1.55, 1.75, 1.95, or 1.15 inches in some embodiments. Skirt 104 may have a maximum outer diameter of 1.96 inches in some embodiments. For example, the maximum outer diameter of skirt 104 at a distal end opposite body 102 may be about 1.6, 1.8, 2, 2.2, or 2.4 inches. Though again, applicator 100 can be made and used in any size. Nozzle 112 can comprise a frustoconical geometry.

With reference to FIG. 3, applicator 100 is shown in a side elevation view rotated 90 degrees from the view of FIG. 2, in accordance with various embodiments. An outer surface of nozzle 112 can be seen through opening 108 defined by skirt 104. Tip 114 is protruding about 0.15 inches from rim 106 of skirt 104. Opening 108 has a height of about 0.17 inches and a width of about 0.26 inches in this example embodiment. Body 102 in the example embodiment of FIG. 3 also has an outer diameter of about 0.71 inches. Though yet again, the various features of applicator 100 can be made and used in any size.

Referring now to FIG. 4, applicator 100 is shown in cross-section taken along line A-A of FIG. 3, in accordance with various embodiment. Applicator 100 includes rim 126 of body 102 defining opening 128 into upper chamber 124. Upper chamber 124 may be cylindrical in shape defined by the inner diameter of body 102. Inner diameter of body 102 may be about 0.47 inches, and the height of body 102 may be about 0.9 inches. Upper chamber 124 may be any size and shape suitable for receiving the nozzle of a pesticide delivery device. Some pesticide delivery devices may press against the inner diameter of body 102 to form a seal that tends to restrict pesticide from ejecting from the opening defined by rim 126 during application.

In various embodiments, upper chamber 124 forms part of passage 116 defined through the interior of applicator 100. Nozzle 112 defines lower chamber 122. Lower chamber 122 defines a portion of passage 116. Lower chamber 122 may be frustoconical or cylindrical in various embodiments, though an annulus, polygonal ring, or any other shape suitable for passing pesticide may be used. In the depicted example of FIG. 3, lower chamber 122 may have a narrower diameter than upper chamber 124. A shoulder may be formed between upper chamber 124 and lower chamber 122, and the shoulder may engage a nozzle of a pesticide in some embodiments.

In various embodiments, tip 114 of nozzle 112 may have a tapered of frustoconical shape. Tip 114 may have a maximum outer diameter of 0.41 inches and a minimum outer diameter of 0.38 inches at a distal end near rim 118. The taper enables tip 114 to enter or otherwise seal around a hole (also referred to as an opening or aperture) in a slab and engage the slab at the opening along the length of tip 114 and nozzle 112. The dimensions, shapes, and sizes disclosed herein are given for purposes of example only and are not limiting.

Referring to FIG. 5, a top view of applicator 100 is shown, in accordance with various embodiment. When pressed into a slab (i.e., into the page), passage 116 delivers pesticide to the slab. Skirt 104 surrounds nozzle 112 and prevents pesticide from squirting upward (i.e., out of the page) from the slab.

With reference to FIG. 6, a perspective view of applicator 100 is shown, in accordance with various embodiments. Body 102 terminates at a distal end at rim 126. Rim 126 defines an opening into upper chamber 124. Passage 116 extends through body 102. Skirt 104 extends from body 102 to a distal end opposite rim 126.

Various embodiments may be formed as a single unitary piece. In that regard, skirt 104 may be formed integrally with body 102 and nozzle 112. In some embodiments, skirt may be formed separately from nozzle and body, and disposed about nozzle and body in sealed engagement. A rigid applicator 100 may also have rubber seals inserted after manufacturing. Seals might include a seal in the inner diameter of body 102 and a seal on the outer diameter of nozzle 112.

Various embodiments of applicators described herein may be made of molded rubber or foam. Though some embodiments could be plastic or metal, rigid embodiments would tend to have inferior sealing properties compared to a softer material. Softer materials such as rubber tend to deform in response to pressure from a slab or the edge of an opening into the slab, which may result in improved sealing compared to rigid embodiments. Nevertheless, rigid embodiments of skirt 104 would still tend to prevent pesticide or other liquid from spraying up from a slab. Formation techniques other than molding such as 3D printing may be used, for example.

In various embodiments, a delivery device is pushed into upper chamber 124 of applicator 100 (which may also be referred to as a slab injector). Once on the delivery device, applicator 100 is pressed down on previously drilled hole in a slab, and pesticide is urged through passage 116, into the hole drilled in the slab, and under slab. If the liquid is not accepted into the hole in the slab, then the liquid is substantially contained on the surface of the slab by skirt 104. Applicator 100 and skirt 104 thus tend to inhibit or calm liquid from spraying or projecting upwards from a slab or substrate.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. A device, comprising:
a body defining an upper chamber;
a nozzle coupled to the body and defining a lower chamber, wherein a passage defined through the device comprises the upper chamber and the lower chamber; and
a skirt coupled to the body, wherein the skirt is configured to inhibit a liquid escaping from the nozzle in response to the liquid being injected through the nozzle.

2. The device of claim 1, wherein the skirt defines an opening to relieve pressure in response to the liquid being injected through the nozzle.

3. The device of claim 1, wherein the body, the nozzle, and the skirt are formed integrally.

4. The device of claim 1, wherein the body, the nozzle, and the skirt comprise a molded liquid.

5. The device of claim 1, wherein the skirt comprises a bell-shaped geometry.

6. The device of claim 5, wherein the body comprises an annular geometry.

7. The device of claim 1, wherein the skirt terminates at a rim, and wherein a tip of the nozzle protrudes from the skirt past the rim.

8. A device, comprising:
a body;
a nozzle coupled to the body, wherein a passage is defined through the body and the nozzle; and
a skirt coupled to the body and extending about at least part of the nozzle.

9. The device of claim 8, wherein the skirt defines an opening to relieve pressure in response to a liquid being injected through the nozzle.

10. The device of claim 8, wherein the body, the nozzle, and the skirt are formed integrally.

11. The device of claim 8, wherein the body, the nozzle, and the skirt comprise a molded liquid.

12. The device of claim 8, wherein the skirt comprises a bell-shaped geometry.

13. The device of claim 12, wherein the body comprises an annular geometry.

14. The device of claim 8, wherein the skirt terminates at a rim, and wherein a tip of the nozzle protrudes from the skirt past the rim.

15. A method of delivering liquid into a substrate, comprising:
coupling an injector to an applicator, wherein the applicator comprises a body, a nozzle coupled to the body, and a skirt coupled to the body and disposed at least partially about the nozzle;
pressing the applicator towards an aperture defined in the substrate;
injecting a liquid into the substrate through a passage defined by the body and the nozzle; and
calming a projection of the liquid in the skirt in response to the liquid escaping from the substrate or the nozzle.

16. The method of claim 15, wherein pressing the applicator towards the aperture defined in the substrate further comprises sealing a tip of the nozzle against the substrate around the aperture.

17. The method of claim 15, wherein pressing the applicator towards the aperture formed in the substrate further comprises pressing a rim of the skirt against the substrate.

18. The method of claim 15, wherein the skirt defines an opening to relieve pressure in response to injecting the liquid into the substrate.

19. The method of claim 15, wherein the injector comprises a pesticide delivery device pressed against an inner diameter of the body to form a seal.

20. The method of claim 15, wherein the body, the nozzle, and the skirt comprise a molded material.
